(19) United States
(12) Patent Application Publication
(10) Pub. No.: US 2006/0260899 A1
(43) Pub. Date: Nov. 23, 2006

(54) Multiple disc clutch apparatus

(75) Inventor: Manabu Sawayanagi, Shizuoka-ken (JP)

Correspondence Address: MILES & STOCKBRIDGE PC, 1751 PINNACLE DRIVE, SUITE 500, MCLEAN, VA, 22102-3833, US

(73) Assignee: NSK-Warner K.K.

(21) Appl. No.: 11/434,922

(22) Filed: May 17, 2006

(30) Foreign Application Priority Data
May 19, 2005 (JP) 2005-147046

(51) Int. Cl. F16D 13/74

(52) U.S. Cl. 192/70.12

(57) ABSTRACT

A multiple disc clutch apparatus in which a plurality of driven plates and a plurality of driving plates are disposed alternately and slipped to be engaged or disengaged by pressure applied from a piston includes, in a housing storing the driven plates and the driving plates, a cooling means that cools the multiple disc clutch such that when slipping rotation speed is low, a lubricating oil discharge hole on the housing is closed and lubricating oil is retained in the housing and when slipping rotation speed is high, the lubricating oil discharge hole is opened and lubricating oil is released from the housing.

This application claims the benefit of Japanese Patent Application No. 2005-147046 which is hereby incorporated by reference.

### BACKGROUND OF THE INVENTION

1. Field of the Invention

The present invention relates to a multiple disc clutch apparatus capable of effectively enhancing a cooling effect in a drum storing driven plates and driving plates by retaining and releasing lubricating oil in response to rotation speed of the clutch.

2. Related Background Art

In a multiple disc clutch apparatus used for a wet starting clutch (hereinafter called a WSC) and a dual clutch transmission (hereinafter called a DCT), a plurality of driven plates (SP) and driving plates (FP) are disposed alternately and slipped to be engaged or disengaged by pressure applied from a piston.

In Japanese Patent Application Laid-Open No. 2004-76896, a plurality of oil grooves having a discharging angle for discharging oil from the inner periphery to the outer periphery of the friction plate upon rotating the friction plate and a plurality of oil grooves having an intake angle for introducing oil from the outer periphery to the inner periphery of the friction plate upon rotating the friction plate are formed on the friction plate together with substantially the same circumferential separation.

In other words, in Japanese Patent Application Laid-Open No. 2004-76896, the effect for introducing and discharging oil is expected by forming grooves on the friction plates disposed in the drum.

However, in the multiple disc clutch apparatus disclosed in Japanese Patent Application Laid-Open No. 2004-76896, since holes for discharging lubricating oil are formed on the outer peripheral side of the drum, the oil-discharging ability inevitably becomes superior to the oil-introducing ability by the centrifugal force in the drum.

### SUMMARY OF THE INVENTION

The present invention is made in view of the aforementioned problems and has an object to provide a multiple disc clutch apparatus capable of effectively enhancing a cooling effect in a drum storing driven plates and driving plates by retaining and releasing lubricating oil in response to rotation speed of the clutch.

According to an aspect of the present invention, there is provided a multiple disc clutch apparatus in which a plurality of driven plates and a plurality of driving plates are disposed alternately and slipped to be engaged or disengaged by pressure applied from a piston includes, in a housing storing the driven plates and the driving plates, a cooling means that cools the multiple disc clutch such that when slipping rotation speed is low, a lubricating oil discharge hole on the housing is closed so that lubricating oil is retained in the housing and when slipping rotation speed is high, the lubricating oil discharge hole is opened so that lubricating oil is released from the housing.

In an aspect of the present invention, it is preferable that the cooling means in the multiple disc clutch apparatus includes a valve that is disposed on the lubricating oil discharge hole on the housing and opens outward to release lubricating oil by centrifugal force and oil pressure against reacting force of a spring.

In an aspect of the present invention, it is preferable that the cooling means in the multiple disc clutch apparatus includes a weight attached to the spring for opening the lubrication oil discharge hole to release lubricating oil.

In an aspect of the present invention, it is preferable that the spring in the cooling means in the multiple disc clutch apparatus is a leaf spring fixed on the housing for opening and closing the lubricating oil discharge hole to effect control of releasing lubricating oil from the housing or retaining the same therein.

### BRIEF DESCRIPTION OF THE DRAWINGS

FIG. 1 is a schematic cross sectional view of a WSC unit equipped with a multiple disc clutch apparatus according to an embodiment of the present invention.

FIG. 2A is a front view of a clutch drum attached to the multiple disc clutch apparatus according to the embodiment of the present invention and FIG. 2B is a sectional view along b-b line in FIG. 2A.

FIG. 3 is an enlarged sectional view of an encircled portion with a nearly rectangle shape attached with a word “COOL” in FIG. 2B.

### DESCRIPTION OF THE MOST PREFERRED EMBODIMENT

A multiple disc clutch apparatus according to an embodiment of the present invention is explained below with reference to accompanying drawings.

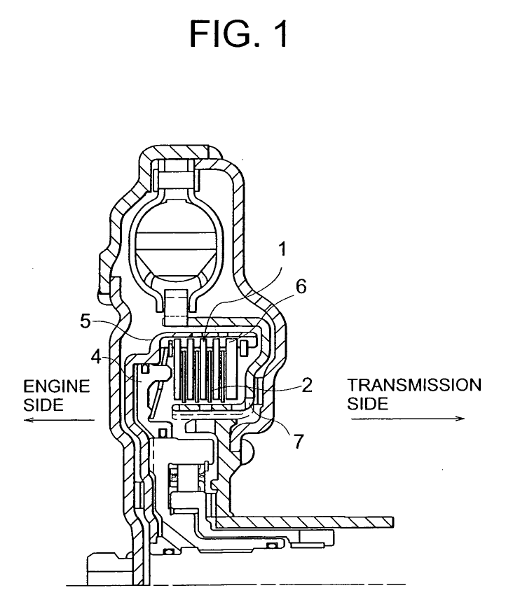

FIG. 1 is a schematic cross sectional view of a WSC unit equipped with a multiple disc clutch apparatus according to an embodiment of the present invention.

In a multiple disc clutch apparatus, driven plates (SP) 1 and driving plates (FP) 2 are arranged alternately overlapping each other with several plates in all. Each driven plate 1 is an externally splined metallic plate. Each driving plate 2 is an internally splined metallic plate. Friction members or linings as a facing member are bounded to the respective surfaces of the driving plate. Alternatively, it is possible that to one surface of each driven plate 1 and to one surface of each driving plate 2 are bounded alternately respective friction members or linings as a facing member.

Driven plates 1 and driving plates 2 are configured to be engaged or released by applying or releasing the pressure from the piston 4. Reference number 5 denotes a clutch drum, reference number 6 denotes a retainer plate, and reference number 7 denotes a hub.

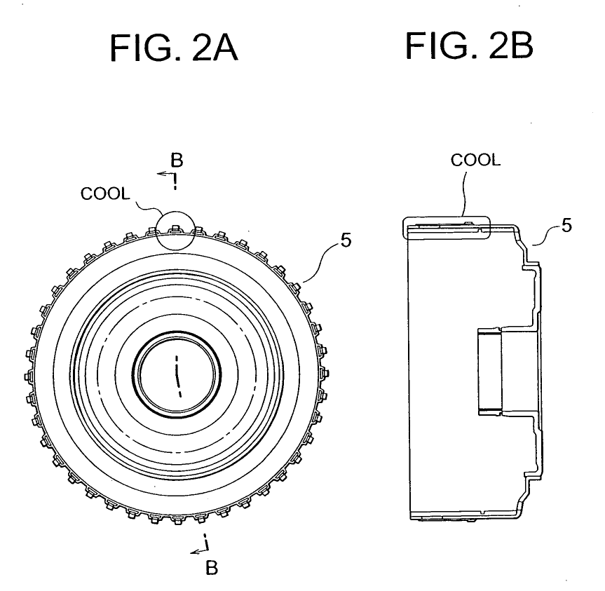

FIG. 2A is a front view of a clutch drum attached to the multiple disc clutch apparatus according to the embodiment of the present invention and FIG. 2B is a sectional view along b-b line in FIG. 2A.

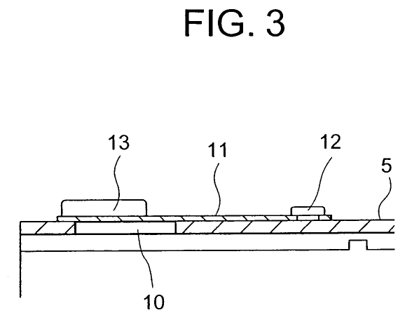

FIG. 3 is an enlarged sectional view of an encircled portion with a nearly rectangle shape attached with a word “COOL” in FIG. 2B.

In FIG. 2B, the encircled portion with a circle or a nearly rectangle shape attached with a word “COOL” is a portion where a cooling means described later is disposed.

According to the present embodiment, in a clutch drum 5 storing the driven plates 1 and the driving plates 2, a cooling means is provided. The cooling means cools the multiple disc clutch such that when slipping rotation speed of the clutch is low, a lubricating oil discharge hole 10 disposed on the clutch drum 5 is closed and lubricating oil is retained in the clutch drum 5 and when slipping rotation speed is high, the lubricating oil discharge hole 10 is opened and lubricating oil is released from the clutch drum 5.

Specifically, the cooling means is configured such that a valve is provided to the lubricating oil discharge hole 10 on the clutch drum 5, and the valve provided to the lubricating oil discharge hole 10 is opened outward to release lubrication oil by centrifugal force and oil pressure against reacting force of a leaf spring 11.

A weight 13 is attached to the leaf spring 11 so that the valve is biased to open the lubricating oil discharge hole 10 to release lubrication oil.

The leaf spring 11 whose base end is fixed to the clutch drum 5 by a rivet 12 closes and opens the lubricating oil discharge hole 10 thereby effecting control of lubrication oil to be retained in or released from the clutch drum 5.

Accordingly, lubrication oil is kept in the clutch drum 5 when slipping rotation speed is low. When slipping rotation speed becomes high, lubrication oil is supplied from the pump, and starting clutch is engaged, a heat release value from friction plates becomes large. In this instance, by properly setting spring coefficient of the leaf spring 11, and a distance to a position of fixing the weight 13, the lubrication oil discharge hole 10 can be opened by the centrifugal force to immediately release lubrication oil.

Therefore, opening and closing of the valve is carried out by the centrifugal force in the clutch drum 5 such that when rotation speed is low, the temperature in the clutch drum 5 does not rise, the lubrication oil is kept in the clutch drum 5, and the amount of lubrication oil from the pump is sufficient to be small, and when rotation speed is high upon engaging the friction plates, since the heat release value becomes large, the amount of lubrication oil from the pump becomes large, so that the generated amount of heat is removed outside together with lubrication oil to be able to enhance cooling efficiency in the clutch drum 5. Accordingly, it becomes possible to improve fuel consumption by more effectively operating the pump than a conventional model.

The present invention is not limited to the above-described embodiment and various modifications are possible. For example, although fixing of the valve shown in the illustrated example is carried out by a rivet 12, any other fixing means other than the rivet may be used.

1. A multiple disc clutch apparatus in which a plurality of driven plates and a plurality of driving plates are disposed alternately and slipped to be engaged or disengaged by pressure applied from a piston comprising, in a housing storing the driven plates and the driving plates:
a cooling means that cools the multiple disc clutch such that when slipping rotation speed is low, a lubricating oil discharge hole disposed on the housing is closed and lubricating oil is retained in the housing, and when slipping rotation speed is high, the lubricating oil discharge hole is opened and lubricating oil is released from the housing.

2. The multiple disc clutch apparatus according to claim 1, wherein the cooling means includes a valve that is disposed on the lubricating oil discharge hole on the housing and opens outward to release lubricating oil by centrifugal force and oil pressure against reacting force of a spring.

3. The multiple disc clutch apparatus according to claim 2, wherein the cooling means includes a weight attached to the spring for opening the lubrication oil discharge hole to release lubricating oil.

4. The multiple disc clutch apparatus according to claim 2, wherein the spring in the cooling means is a leaf spring fixed on the housing for opening and closing the lubricating oil discharge hole to release lubricating oil.

5. The multiple disc clutch apparatus according to claim 3, wherein the spring in the cooling means is a leaf spring fixed on the housing for opening and closing the lubricating oil discharge hole to release lubricating oil.
